(19) United States
(12) Patent Application Publication
(10) Pub. No.: US 2008/0051958 A1
(43) Pub. Date: Feb. 28, 2008

(54) Process For Controlling And Regulating An Active Chasis System

(75) Inventors: Christoph Pelchen, Tettnang (DE); Siegfried Licher, Georgsmarienhutte (DE); Ronald Wellmann, Wallenhorst (DE); Winfried Bunsmann, Bissendorf (DE); Peter Kalinke, Osnabruck (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 11/791,304

(22) PCT Filed: Nov. 19, 2005
(86) PCT No.: PCT/EP05/12408

§ 371 Date: May 22, 2007

(30) Foreign Application Priority Data
Nov. 24, 2004 (DE) 10 2004 056 610.0

(51) Int. Cl. B60G 17/016; B62D 21/00; B62D 25/00

(52) U.S. Cl. 701/37; 280/5.5

(57) ABSTRACT

A process for controlling and adjusting an active chassis system (1) of a vehicle having a sensor device (2) and at least one element (3, 4, 5) for acquiring vehicle accelerations of the chassis system (1). The mode of operation of the one or more elements (3, 4, 5) is modified by a control device (6) which is in operative connection with the sensor device (2) such that subframe oscillations occurring while driving are minimized. Torsional oscillations of the body are determined by the sensor device (2) and the control device (6). The mode of operation of the element (3, 4, 5) is adjustably controlled by the control device (6) to counteract the calculated torsional oscillations of the body.

This is a national stage completion of PCT/EP2005/012408 filed Nov. 19, 2005 which claims priority from German Application Serial No. 10 2004 056 610.0 filed Nov. 24, 2004.

### FIELD OF THE INVENTION

The present invention relates to a process for controlling and adjusting an active chassis system.

### BACKGROUND OF THE INVENTION

From practical experience, the performance of a vehicle is adjusted, while taking a desired driving comfort as well as the required driving safety into account, by means of an appropriate vehicle configuration and an adequate torsion-resistant arrangement of the chassis, which enable the vehicle to counteract the forces affecting it during its operation and the resulting motions, with the desired effect. In the configuration of the above mentioned vehicle systems, driving dynamics, an area of technical mechanics and/or vehicle dynamics concerning the forces affecting the vehicle and resulting vehicle motions is presented. The subject of driving dynamics is basically divided into the longitudinal dynamics, transverse dynamics and vertical dynamics of a vehicle.

Longitudinal dynamics concern the interaction of driving and braking forces on the wheels and driving resistances dependent on the road surface and operating conditions. Thus, among other things, longitudinal dynamics provide important conclusive information on fuel consumption, acceleration capacity and configuration of the power train and brake system.

Transverse dynamics concern forces, like crosswinds or centrifugal forces, that displace the vehicle from its driving direction. These forces can only be compensated by directional control forces of the tires and/or wheels, the rubber-tired wheel rolling at a corresponding slip angle with reference to its center plane. The dynamic wheel load, driving and braking forces as well as frictional properties of the road surface also exert their influence. The center of gravity, point of application of the wind force, construction of the wheel suspension and tire properties determine the handling performance, which together with the driver's reactions bear on drivability, roadholding at straight-forward driving and cornering stability.

Vertical dynamics concern the vertical forces and movements generated by road surface irregularities that produce bouncing and pitching motion around the lateral axis by interposition of the tire suspension and vehicle suspension, and which are reduced with dampers. During cornering, the vehicle tends to roll around the longitudinal axis. This is dependent on the axle arrangement and may be controlled with stabilizers.

Improvement of the driving dynamics is attempted by using electronic control systems, where the longitudinal dynamics may, for example, be controlled by an anti-locking system, the transverse dynamics, for example, by automatically adjusting the driving dynamics with specific influence on the yawing moment by brake action, as well as the vertical dynamics by reducing the rolling tendency of the subframe and managing the damping properties by electronic chassis adjustment.

Currently, so called active chassis systems are used for active reduction of subframe oscillations which result from skidding, bouncing and yawing motion around the vertical axis, longitudinal axis and transverse axis of the vehicle. The subframe is viewed as a rigid structure in the operation of these active chassis systems, and the individual components of the active chassis systems are controlled and/or the mode of operation of the individual components of the active chassis systems are adjusted, in each case, such that the subframe oscillations are reduced, as desired, to a frequency range of max. 5 Hz and/or completely prevented.

In this context, dampers with continuously modifiable characteristics, active twistable actuators in stabilizers, as well as length-adjustable actuators in the area of the vehicle suspension are components of active chassis systems, which are controlled by set values determined as a function of vehicle accelerations recorded by a sensor device and resultant algorithms, so that the subframe oscillations are reduced as desired taking into consideration the current vehicle operating conditions.

Active chassis systems, developed with length-adjustable actuators in a subframe suspension of a vehicle, are arranged, for example, as an electro-hydraulic suspension system, which keeps the subframe level in all driving situations. With chassis systems of this type, the suspension and dampers are modified and level adjustment is made possible. For this purpose, vertically adjustable hydraulic cylinders are arranged in each suspension strut. The more oil pumped into the hydraulic cylinder, the stronger the spring will be pretensioned and the larger its spring force will be. The oil flow as such is controlled by check and stop valves. The pressure is led either to the hydraulic cylinder or return line via the check valves. The stop valves, for example, stop the supply when the motor stalls or upon malfunction of the chassis system. All valves are preferably operated electromagnetically and are positioned on the axles as valve units, each spring strut being individually adjustable.

Active chassis systems having dampers with continuously modifiable characteristics offer the possibility of adapting the damping rate to the respective operating conditions in a fraction of a second. The self-checking control and adjustment device, for example, comprises speed, transverse acceleration and road surface condition sensors, a computer unit with intelligent software and actuators. One of the actuators is designed as a proportional damper valve by means of which the damping forces are continuously adjustable between a maximum and minimum value.

The active chassis systems known from practical experience arranged with active twistable actuators in the stabilizers comprise, among other things, two active stabilizers, a valve block with incorporated sensors, a pump, a transverse acceleration sensor, a control device and further supply components. The essential elements of such chassis systems are both active stabilizers, which are incorporated in the area of the front and rear axle, instead of conventional mechanical stabilizers. The actuator is a hydraulic oscillating motor, in which the oscillating motor shaft and oscillating motor housing are respectively connected to one half of the stabilizers. The active stabilizers transform the hydraulic pressure into a torsional moment and/or stabilization moment, via the connection.

The hydraulic pressure is controlled, via two electronically adjusted pressure regulation valves, such that the rolling motion of the subframe is minimized or completely eliminated during cornering to achieve high agility and precision over the entire speed range, resulting in optimized self-driving, and management of load change performance. On the other hand, the actuators are depressurized during straight-forward driving and/or minor transverse accelerations, so that the torsion spring rate of the stabilizer cannot stiffen the basic suspension, reducing the copy motion of the subframe.

Wheel oscillations caused by read surface irregularities further lead to so-called torsional oscillations of the body, which are disturbing to the driver and reduce comfort. In particular, convertible vehicles present less torsional rigidity compared to hard-top vehicles because the vehicle roof is not firmly joined to the vehicle body, and therefore they are especially sensitive to wheel stimuli. Some traditional measures to reduce body oscillations are passive body mass dampers or active oscillation reduction systems.

A motor vehicle is known from DE 198 20 617 A1, which has an oscillation damping device and/or active oscillation reduction system, in which active length-adjustable actuators are incorporated in the force flow of the torsional oscillations of the body. The torsional oscillations of the body are actively reduced by a device for controlling the actuators based on an exemplary twistable vehicle body, arranged anti-phase to the torsional oscillations of the body. Convertible bodies are further arranged with higher torsional rigidity, using additional material to minimize the torsional oscillations of the body which occur during use.

The above mentioned known measures for the reduction of torsional oscillations of vehicle bodies, however, disadvantageously result in a clear increase in the weight of the vehicle, which is not desired because of the reduction in both fuel consumption and agile driving performance.

It is therefore the object of the present invention to make a process for controlling and adjusting an active chassis system available for a vehicle, by means of which torsional oscillations of the body may be reduced in comparison with traditional motor vehicles, without increasing the weight of the vehicle.

### SUMMARY OF THE INVENTION

The process according to the present invention for controlling and adjusting an active chassis system of a vehicle having a sensor device for recording motor vehicle accelerations and at least one element of the chassis system advantageously offers the possibility of easily and cost-effectively reducing torsional oscillations of the body during vehicle operation. The element of the chassis system has a mode of operation that is modifiable via a control device in operative connection with the steering device, such that subframe oscillations occurring during operation are minimized.

To achieve this, the mode of action of the controllable element for the reduction of subframe oscillations is also variably controlled and adjusted to counteract these torsional oscillations of the body.

By using a component that is already applied in motor vehicles known from practical experience, i.e. an active chassis system for the reduction of subframe oscillations and for the compensation of torsional oscillations of the body, an additional system for reducing torsional oscillations of vehicle bodies, such as an already known body mass damper, a separate active system and/or active oscillation reduction system, can advantageously be dispensed with. This leads to a reduction of the manufacturing costs of a vehicle as well as a reduction in installation space requirements, which will then be available for other vehicle components.

Additionally, the overall weight of a vehicle is reduced by the control device according to the present invention when compared to known active chassis system because additional active or also passive systems for the reduction of torsional oscillations of the body can be dispensed with, and the body as such may be arranged with less torsion resistance moment in comparison with traditional motor vehicles.

According to the present invention, an active chassis system already available in a vehicle, for minimizing subframe oscillations which occur during vehicle operation, is designated for active reduction of torsional oscillations of the body, which preferably have a maximum range of 20 Hz. The occurring torsional oscillations of the body are recorded by appropriate sensors and/or a sensor device. By means of an appropriate operation and adjustment strategy recorded by a control device, the mode of operation of at least one element of the active chassis system is respectively varied so that the torsional oscillations of the body, occurring during vehicle operation, are actively reduced.

In a further advantageous embodiment of the present invention, it is provided that control and adjustment of the element for minimizing the torsional oscillations of the body also controls and adjusts the element for minimizing the subframe oscillations to ensure that the oscillations, of the subframe, as well as the torsional oscillations of the body, are reduced to a desired extent in comparison with traditional motor vehicles, and significantly increased comfort to the passengers of the vehicle is achieved.

### BRIEF DESCRIPTION OF THE DRAWINGS

The present invention is explained in more detail hereinafter in the exemplary arrangement with reference to the drawing in which:

FIG. 1 is a very schematic illustration of an active chassis system of a motor vehicle, which includes a sensor device for recording motor vehicle accelerations using several elements of the chassis system.

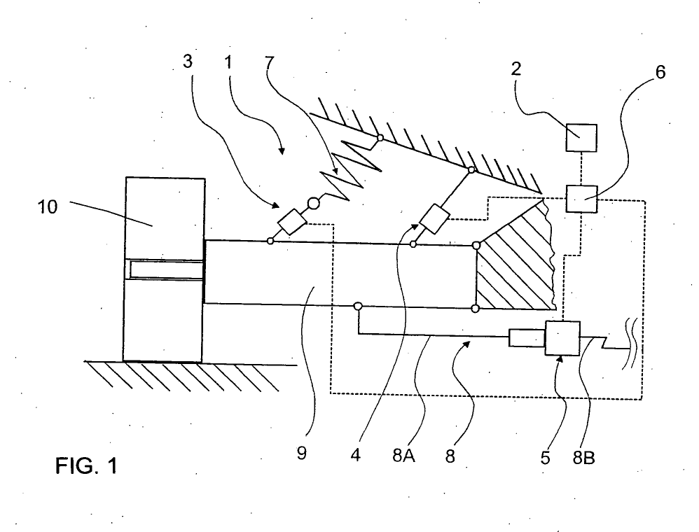

### DETAILED DESCRIPTION OF THE INVENTION

A part of the very schematically illustrated active chassis system 1 for a vehicle with a sensor device 2 for recording motor vehicle accelerations and with several elements 3, 4 and 5 of the chassis system 1 is shown in the Fig. The mode of operation of the elements 3 to 5 may be varied with a control device 6 in operative connection with the sensor device 2 in a principly known manner, such that subframe oscillations occurring during operation are minimized.

In this regard, the sensor device 2 comprises several acceleration sensors which are uniformly distributed over the subframe, by means of which accelerations around the vertical axis, longitudinal axis and transverse axis of the vehicle are acquired. On the basis of the values of the acceleration sensors, so-called subframe oscillations are in the control device 6 under the assumption of an absolutely rigid subframe, and the required set values are again determined by means of an adequate algorithm, which are encoded for the elements 3 to 5 as controlling and adjusting values for the elements 3 to 5 of the active chassis system 1 in order to balance and/or at least compensate for the subframe oscillations acquired by the control device 6 in a range between 0 Hz and 7 Hz, preferably in a range between 0 Hz and 5 Hz.

Further, on the basis of values acquired by the sensor device 2 and/or its acceleration sensors, so-called torsional oscillations of the body and respective control and adjustment values for the elements 3 to 5 are determined by means of a further algorithm, so that torsional oscillations of the body are reduced and/or at least compensated for within a range between 10 Hz and 40 Hz, preferably within a range between 10 Hz and 20 Hz.

In this context, it is provided that depending on the respectively available operating conditions, the mode of operation of one of the elements 3 to 5 alone, the mode of operation of respectively two of the three elements 3 to 5, or the mode of operation of all the elements 3 to 5 at the same time is modified giving consideration to the control of the other elements 3 to 5, to counteract the calculated torsional oscillations of the body to the desired extent.

The first element 3 is presently arranged as a length-adjustable actuator of a subframe spring mechanism 7, the length of the actuator 3 being respectively modifiable so that pretensioning of the subframe spring mechanism 7 is modified as a function of the respectively acquired operating condition of the vehicle and that the mode of operation of the first element 3 counteracts the torsional oscillations of the body calculated by the control device 6 in the above mentioned frequency range within a few milliseconds, such that the torsional oscillations of the body are at least nearly eliminated.

The second element 4 is arranged, in the exemplary embodiment of the active chassis system illustrated in the Fig. as a damper assigned to a wheel 10 with continuously variable characteristics. The characteristics and/or damping rate of the damper 4 is modified as a function of the respectively calculated operating condition of the vehicle, such that torsional oscillations of the body occurring during vehicle operation are minimized in comparison to traditionally arranged motor vehicles. In this regard, the damping force of the damper 4 may be varied continuously between a minimum and maximum value, so that torsional oscillations of the body calculated by means of the sensor device 2 and the sensor device 6 may be counteracted to the desired extent via the respective characteristics of the damper 4.

The third element of the chassis system 1 is presently designed as an active twistable actuator of a stabilizer device 8, which among other things, consists of two active stabilizers 8A and 8B. Both active stabilizers 8A, 8B are twistable against each other depending on the calculated torsional oscillations of the body related to the operating condition via the twistable actuator 5, such that a hydraulic pressure generated by the control device 6, via a pumping device, not illustrated in detail, is transformed into a torsional moment and/or, via the connection of both stabilizers 8A, 8B to a chassis 9 into a stabilization moment.

Controlling and adjusting the elements 3 to 5 for reducing the subframe oscillations, and controlling and adjusting the elements 3 to 5 for reducing torsional oscillations of the body, are presently superimposed on each other, so that as a function of the respectively calculated and/or present operating condition of a vehicle, the subframe oscillations and the torsional oscillations of the body that respectively occur in different frequency ranges, as calculated by means of the sensor device 2 and sensor device 6, may be easily and effectively counteracted to the desired extent. The control of the elements 3 to 5 of the chassis system 1 is carried out such that the functionality of the elements 3 to 5 for the reduction of the subframe oscillations is not significantly affected by the control and adjustment to reduce the torsional oscillations of the body. In addition, it is, however, provided that the functionality of the elements 3 to 5 for reduction of the torsional oscillations of the body are only marginally affected by the control and adjustment of the elements 3 to 5 to reduce the subframe oscillations.

Notwithstanding the above, it may also be provided that control of the elements 3 to 5 of the active chassis system 1 for reducing the subframe oscillations is given priority over control and adjustment of the elements 3 to 5 for reducing the torsional oscillations of the body. In this case, the control and adjustment of the elements 3 to 5 is performed so that first, the subframe oscillations are reduced to the desired extent and/or eliminated, and only after fulfillment of this purpose, are the torsional oscillations of the body actively counteracted by respective control and adjustment of the elements 3 to 5 without affecting the compensation of the subframe oscillations.

Another variant of the process for controlling and adjusting the active chassis system 1 according to the present invention may further be provided, where control and adjustment of the elements 3 to 5 for reducing the torsional oscillations of the body are given priority over control and adjustment of the elements 3 to 5 of the subframe oscillations to the effect that the mode of operation of the elements 3 to 5 of the active chassis system 1 are modified in relation to the operating condition such that in the first instance, the calculated torsional oscillations of the body are reduced and/or nearly largely eliminated, and subsequently the calculated subframe oscillations are actively counteracted by respective control and adjustment of the elements 3 to 5, without affecting the compensation of the torsional oscillations of the body.

### REFERENCE NUMERALS

1 Chassis system
2 Sensor device
3, 4, 5 Element
6 Control device
7 Subframe spring mechanism
8 Stabilizer device
8A, AB Active stabilizer
9 Chassis
10 Wheel

1-10. (canceled)

11. A process for controlling and adjusting an active chassis system (1) of a vehicle having at least one element (3, 4, 5) of the chassis system (1) and a sensor device (2) for acquiring vehicle acceleration, the at least one element (3, 4, 5) having a mode of operation that is modifiable via a control device (6), the control device (6) is operatively connected with the sensor device (2) such that subframe oscillations, occurring during operation of the vehicle, are minimized, the process comprising the steps of:
determining torsional oscillations of a vehicle body with the sensor device (2) and the control device (6); and
controllably and adjustably modifying the mode of operation of the at least one element (3, 4, 5) with the control device (6) to counteract the determined torsional oscillations of the vehicle body.

12. The process according to claim 11, further comprising the step of designating a second element (4) as a damper for a wheel, the second element (4) having continuously variable characteristics that are modifiable such that the torsional oscillations of the vehicle body, occurring during vehicle operation, are minimized.

13. The process according to claim 11, further comprising the step of designing a third element (5) as an actively twistable actuator of a stabilizer device (8), twisting the actively twistable actuator (5) such that the torsional oscillations of the vehicle body, occurring during vehicle operation, are minimized.

14. The process according to claim 11, further comprising the step of configuring the at least one element (3) as a length-adjustable actuator of a subframe spring mechanism (7), and adjusting a length of the length-adjustable actuator (3) such that the torsional oscillations of the vehicle body, occurring during vehicle operation, are minimized.

15. The process according to claim 11, further comprising the step of controlling and adjusting the at least one element (3, 4, 5), during vehicle operation, such that the torsional oscillations of the vehicle body are counteracted at least to within in a range of approximately between 10 Hz and 20 Hz.

16. The process according to claim 11, further comprising the step of controlling and adjusting the at least one element (3, 4, 5), during vehicle operation, such that the subframe oscillations are counteracted at least to be within a range of approximately between 0 Hz and 5 Hz.

17. The process according to claim 11, further comprising the step of controlling and adjusting the at least one element (3, 4, 5) to minimize the subframe oscillations before controlling and adjusting the at least one element (3, 4, 5) to minimize the torsional oscillations of the vehicle body.

18. The process according to claim 11, further comprising the step of controlling and adjusting the at least one element (3, 4, 5) to minimize the torsional oscillations of the vehicle body before controlling and adjusting the at least one element (3, 4, 5) to minimize the subframe oscillations.

19. The process according to claim 11, further comprising the step of concurrently controlling and adjusting the at least one element (3, 4, 5) to minimize the torsional oscillations of the vehicle body and minimize the subframe oscillations.

20. The process according to claim 11, further comprising the step of providing at least two elements (3, 4 or 5), each having a mode of operation respectively modifiable depending on the mode of operation of the other of the at least two elements (3, 4 or 5) such that the torsional oscillations of the vehicle body, occurring during vehicle operation, are minimized.

21. A method of controlling and adjusting an active chassis system (1) of a vehicle to reduce torsional oscillation of a body of the vehicle and vehicle subframe oscillation caused during operation of the vehicle, the method comprising the steps of:
acquiring vehicle accelerations with at least one element (3, 4, 5) of the active chassis system (1) and a sensor device (2), and the at least one element (3, 4, 5) communicating with chassis system (1);
determining the torsional oscillation of the body of the vehicle, via the sensor device (2) and a control device (6) with the sensor device (2) communicating with the control device (6);
controllably altering operation of the at least one element (3, 4, 5) of the chassis system (1), via the control device (6), to reduce the vehicle subframe oscillations; and
further controllably altering the operation of the at least one element (3, 4, 5), via the control device (6), to reduce the determined torsional oscillations of the body of the vehicle.
